(19) United States
(12) Patent Application Publication
(10) Pub. No.: US 2013/0114048 A1
(43) Pub. Date: May 9, 2013

(54) HEIGHT ADJUSTABLE PROJECTOR SCREEN SUPPORT

(71) Applicants: Slobodan Konjhodzic, Skarholmen (SE); Jonas Håkansson, Danderyd (SE); Ali Nekzada, Segeltorp (SE)

(72) Inventors: Slobodan Konjhodzic, Skarholmen (SE); Jonas Håkansson, Danderyd (SE); Ali Nekzada, Segeltorp (SE)

(73) Assignee: SMS SMART MEDIA SOLUTIONS AB, Nacka (SE)

(21) Appl. No.: 13/810,631

(22) PCT Filed: May 25, 2011
(86) PCT No.: PCT/SE11/50648

§ 371 Date: Jan. 16, 2013

(30) Foreign Application Priority Data
Jul. 16, 2010 (SE) 1000770-6

(51) Int. Cl. G03B 21/10

(52) U.S. Cl. CPC G03B 21/10
USPC 353/79; 248/295.11; 248/205.1

(57) ABSTRACT

A projector screen support (2) is described comprising a support structure (5) with at least one guide means (6, 7) defining a length axis {8, 9) which is to be arranged essentially vertically and a screen holding support (10) for holding a projector screen (3). The screen holding support (10) is arranged movable along the length axis (8, 9), defined by said at least one guide means (6, 7). The projector screen support (2) also comprises counterbalancing means arranged to apply a force directed upwards on the screen holding support (10) in relation to the support structure (5). The counterbalancing means comprises at least two constant force springs (13) each producing a predetermined force, wherein the springs (13) are attachable/detachable in at least one end without using any tools, so that the total force from the counterbalancing means may be easily varied by attaching or detaching springs (13).

### TECHNICAL FIELD

The present invention relates to a projector screen support. More specifically the present invention relates to a projector screen support for a projector screen and a short throw projector, which is to be arranged on the projector screen support together with a screen.

### DESCRIPTION OF THE PRIOR ART

When presenting information stored in a computer it is possible to connect the computer to a projector, which shows the files stored on the computer. In recent years so called “short-throw-projectors” have entered the market. Short throw projectors are sometimes referred to as “ultra short throw projectors”. In the following description the term “short throw projector” will be used for both types of projectors. Such projectors can be placed at a short distance from the screen on which the images from the projector are projected. Such projectors are normally arranged on an arm which extends from the screen so that the projector and screen are arranged fixed in relation to each other. In order to facilitate the display of information, the screen and the projector may be arranged on a height adjustable support so that the screen may be positioned at different heights above the surface on which the support is arranged.

The height adjustability may be provided in one of many ways. The US application US 2009/0015798 A1 describes a display system incorporating a display surface and a short throw projector arranged to project an image onto the display surface. The display surface and the short throw projector are height adjustable by means of two elongated actuators, which may be controlled mechanically or electrically, for example by remote control.

PCT/US2005/000930 describes interactive display system including a support frame having a vertical positioning element that counterbalance the weight of an attached interactive display. The vertical positioning element includes hydraulic or pneumatic devices such as pistons and gas springs.

U.S. Pat. No. 3,822,848 describes a picture screen holder of the wall mounted bracket type and provides for manual adjustment of the screen in a vertical direction.

### SUMMARY OF THE INVENTION

An object of the present invention is to provide a height adjustable projector screen support, which is an alternative to the projector screen supports according to the prior art.

Another object of the present invention is to provide a height adjustable projector screen support, for a projector screen, which comprises counterbalancing means for counterbalancing the weight of the screen and which is easily adjustable in height.

A further object of the present invention is to provide a height adjustable projector screen support, for a screen and a short throw projector, which comprises counterbalancing means for balancing the weight of the screen and the projector, wherein the force from the counterbalancing means is easily adjustable.

Still another object of the present invention is to provide a height adjustable projector screen system, with a screen and a short throw projector, which comprises counterbalancing means for balancing the weight of the screen and the projector wherein the force from the counterbalancing means is easily adjustable.

At least one of the above objects are fulfilled with a projector screen support according to claim 1.

Further advantages of the invention are provided with the features of the dependent claims.

According to a first aspect of the invention a projector screen support is provided. The projector screen support comprises a support structure with at least one guide means defining a length axis which is to be arranged essentially vertically. The projector screen support also comprises a screen holding support for holding a projector screen, which screen holding support is arranged movable along the length axis, defined by said at least one guide means, in relation to said at least one guide means on the support structure. The projector screen support also comprises counterbalancing means arranged to apply a force directed upwards on the screen holding support in relation to the support structure. The counter-balancing means comprises at least two constant force springs in the form of rolled ribbons of spring steel, which each have a roll axis, wherein the roll axes are arranged essentially parallel to each other, wherein each spring produces a pre-determined force. The projector screen support is characterized in that the springs are attachable/detachable in at least one end, so that the total force from the counterbalancing means may be easily varied by attaching or detaching springs.

With a projector screen support according to the first aspect of the invention the force from the counterbalancing means may be adapted to different weights on the projector screen.

Constant force springs in the form of rolled ribbons of spring steel are readily available and provide an essentially constant force independently of their extension. Such springs are in the form of a roll with one free end that may be extended from the roll in a straight line.

The projector screen support is particularly intended for use with short throw projector. To this end the screen holding support may also comprise an arm extending essentially perpendicularly to the length axis defined by said at least one guide means. The arm may be arranged for the arrangement of a short throw projector.

With such an arm the short throw projector may easily be arranged fixed in relation to the screen. It is especially important to have the force from the counterbalancing means variable when having a projector screen as well as a projector arranged on the screen holding means as the weight may vary within a larger interval with such an arrangement compared with the case of only having a projector screen arranged on the screen holding support.

Preferably, the springs are attachable/detachable without using any tools. This may be provided in a number of different ways. Furthermore, means may be provided for securing the springs in the attached position.

The outer end of at least one of the constant force springs in the form of rolled ribbons of spring steel may be provided with a hole having a decreasing width towards the outer end of the constant force spring, which hole is to be in engagement with a knob having a length axis and a form at the outer end of the knob so that when the outer end of the hole is in engagement with the knob the spring is prevented from moving along the length axis of the knob out of engagement with the knob. With such a hole the spring may be easily attached by pulling out the spring until the knob may be inserted through the hole. When the pulling force on the spring is released the spring retracts so that the knob enters the outer end of the hole. In that position the spring may not be pilled out from the knob in a direction along the length axis of the knob. In order to detach the spring from the knob the spring first has to be pulled down so that the knob then may exit through the part of the hole with the largest width.

The hole may preferably have a form resembling the form of a keyhole.

The knob may have one of many different forms as long as the knob fulfils the requirement to lock the spring in position at the outer end of the hole, into which end the knob is forced due to the force from the spring. The knob may be a screw with a screwhead.

With the knob having the form of a screw with a screw head the attached spring may be secured by tightening the screw. When the spring is to be detached it is first unsecured by rotation of the screw in the opposite direction.

A plate may be arranged attached to the outer end of the constant force spring, in which plate the hole is formed. Such a spring is easier to manufacture as the material in the plate may be chosen freely to be easily machined.

The outer part of the plate may be formed with a gripping part. The gripping part may for example be formed by bending the outermost part of the plate in an angle to the rest of the plate.

With the constant force springs in the form of rolled ribbons of spring steel the constant force springs may comprise springs of at least two different strengths, i.e. which produce forces of at least two different magnitudes. With such an arrangement the force from the counterbalancing means may be altered in finer steps. Constant force springs in the form of rolled ribbons of spring steel may also be called roll formed coil springs.

The constant force springs may be arranged fixed in relation to the screen holding support and arranged attachable/detachable in relation to the support structure. It is of course possible to have it in the opposite way with the constant force springs fixed in relation to the support structure. It is preferably the free end that is arranged fixed.

The support structure may comprise at least one shelf on which the constant force springs may be arranged rotatable around their roll axes. Having the constant force springs arranged on such a shelf provides for an easy attachment/detachment of the constant force springs. It is of course possible to have a separate shelf for each one of the constant force springs.

The shelf may comprise a length axis which is arranged essentially perpendicular to the length axis defined by said at least one guide means and wherein the constant force springs are arranged to be placed on the shelf with their roll axes essentially parallel to the length axis of the shelf. The length axis of the shelf is preferably also parallel to a projector screen arranged on the screen holding support.

In a cross section perpendicular to the length axis of the shelf the shelf may be bent upwards in the outermost part of the shelf so that the constant force springs are prevented from rolling off the shelf. With such an arrangement the constant force springs are prevented from rolling off the shelf while they still are easily attachable/detachable from the shelf.

The side of the shelf that is arranged to be in contact with the constant force spring may be provided with contact means which provide low friction between the constant force spring and the contact means. The contact means may be of any suitable material providing low friction against the constant force spring, such as, e.g., some plastic.

The inner end of the constant force spring is preferably arranged around an axle. The arrangement of the constant force spring around an axle provides a construction with a longer lifetime and also with a potentially lower friction. The friction between the projector screen support and the support structure may then be adjusted by other means.

Preferably the axle is journalled in the support structure. The axle may be journalled in slide bearings. Slide bearings provide a cost efficient solution for the projector screen support. It is, however, possible to use roller bearings in case an even lower friction is required.

The support structure may be arranged to be attached to a wall. Alternatively the support structure may be arranged on a base for placement on a floor. To this end the support structure may have an attachment surface and be arranged to be attached to a wall with the attachment surface against the wall.

Preferably, the constant force springs are arranged so that they are released by moving the outer end of the coil spring away from the attachment surface, i.e., the coil springs are arranged on the side of the support structure facing away from the attachment surface. In this way space for the movement of the springs is easy to achieve without having to make the support structure unnecessarily thick. By removing the projector screen from the projector screen support space for the movement is readily provided.

According to a second aspect of the present invention a projector system is provided. The projector system comprises a projector screen support according to any one of the preceding claims, a projector screen, and a projector. With such a projector system the force from the counterbalancing means may be easily adapted to the weight of the projector screen and the projector.

In the following preferred embodiments of the invention will be described with reference to the appended drawings.

### SHORT DESCRIPTION OF THE DRAWINGS

FIG. 1 is a rear perspective view of a projector system according to an embodiment of the present invention comprising a projector screen support, a projector screen and a projector.

FIG. 2 is a front perspective view of the projector screen support of the projector system shown in FIG. 1.

FIG. 3 shows a part of the projector screen support of FIG. 2 in more detail.

FIG. 4 is a front view of the projector screen support.

FIG. 5 is a cross sectional view of the projector screen support along D-D in FIG. 4.

FIG. 6 is a cross sectional view of a part of the projector screen support in FIG. 5.

FIG. 7 is a front perspective view of a projector screen support according to an alternative embodiment of the present invention.

FIG. 8 shows a part of the projector screen support of FIG. 7 in more detail.

### DESCRIPTION OF PREFERRED EMBODIMENTS OF THE INVENTION

In the following description of preferred embodiments of the invention similar elements or features in different figures will be denoted with the same reference numeral. It is to be noted that the drawings are not drawn to scale.

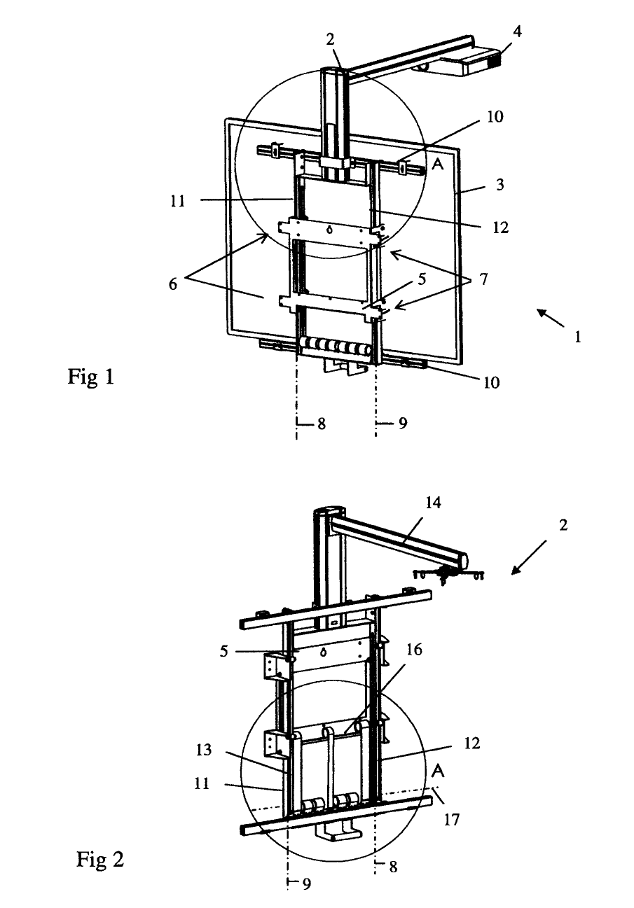

FIG. 1 is a rear perspective view of a projector system 1 according to an embodiment of the present invention comprising a projector screen support 2, a projector screen 3 and a projector 4. The projector screen support 2 comprises a support structure 5 with two guide means 6, 7, defining length axes 8, 9, which are to be arranged essentially vertically. The projector screen support 2 also comprises a screen holding support 10 for holding the projector screen 3, which screen holding support 10 is arranged movable along the length axes 8, 9, defined by said guide means 6, 7, in relation to said guide means 6, 7, on the support structure 5. In the shown embodiment the screen holding support 10 comprises two rails 11, 12, which are arranged in the guide means 6, 7. It is of course possible to arrange the rails on the support structure 5 and guide means 6, 7, on the screen holding support 10.

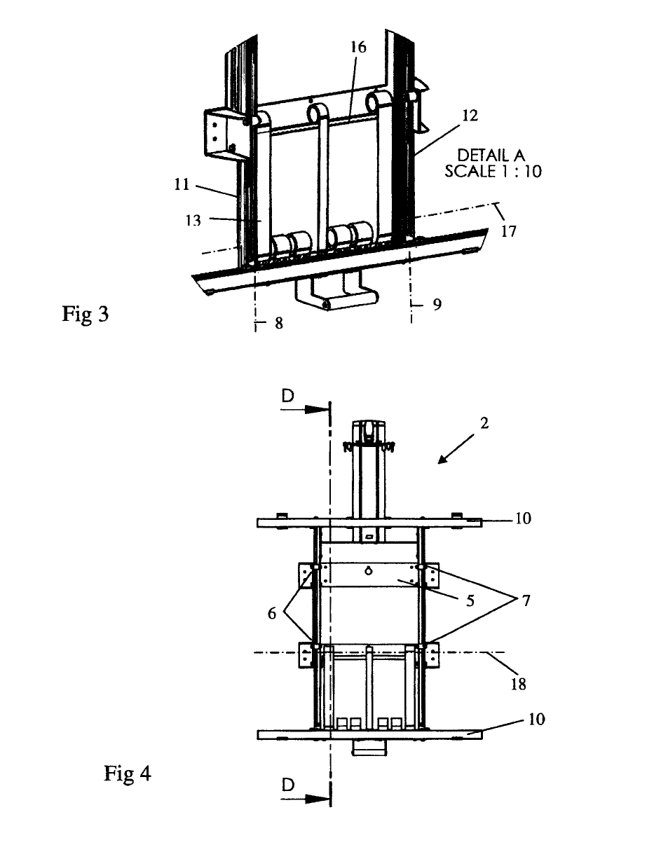

The projector screen support 2 also comprises counterbalancing means arranged to apply a force directed upwards on the screen holding support 10 in relation to the support structure 5. In the shown embodiment the counterbalancing means comprises seven constant force springs in the form of constant force springs 13 each producing a predetermined force. In the shown embodiment the constant force springs are attached to the screen holding support in one end while the other ends of the constant force springs 13 are in the form of rolls that are in contact with the support structure so that the constant force springs may apply an upward force on the screen holding support 10 in relation to the support structure 5. The arrangement of the constant force springs 13 on the support structure 5 will be shown in more detail in FIG. 3 and FIG. 4.

The screen holding support 2 also comprises an arm 14 extending essentially perpendicularly to said at least one guide means 6, 7. The arm is arranged for the arrangement of a short throw projector 4.

FIG. 2 is a front perspective view of a projector screen support 2 similar to that shown in FIG. 1. FIG. 3 shows a part of the projector screen support 2 of FIG. 2 in more detail. The support structure 5 comprises a number of constant force springs 13 of different sizes with roll axes 17. The constant force springs of different sizes have different strengths, i.e. they produce forces of different magnitudes. The support structure 5 comprises a shelf 16 on which the constant force springs may be arranged rotatable around their roll axes 17.

The shelf 16 comprises a length axis 18 which is arranged essentially perpendicular to the length axes 8, 9, defined by the guide means 6, 7, and wherein the constant force springs 13 are arranged on the shelf with their roll axes 17 essentially parallel to the length axis 18 of the shelf 16. In FIG. 2 and FIG. 3 three of the constant force springs are arranged on the shelf 16. The constant force springs may easily be attached/detached from the shelf 16 without using any tools. Thus the total force from the counterbalancing means may easily be varied by attaching or detaching springs from the shelf 16. This makes it possible to vary the force from the counterbalancing means in dependence of the weight of the projector and projector screen.

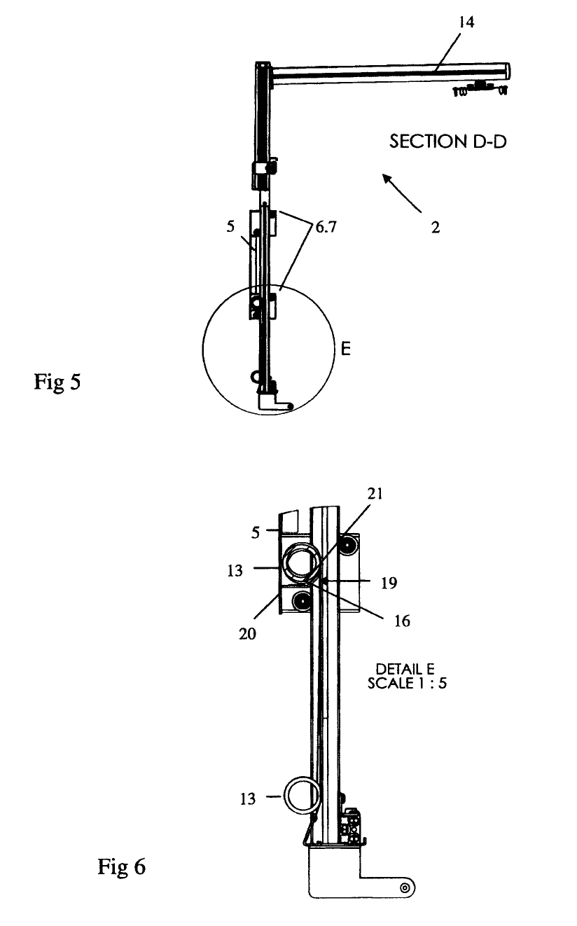

FIG. 4 is a front view of the projector screen support 2. FIG. 5 is a cross sectional view of the projector screen support 2 along D-D in FIG. 4. FIG. 6 is a cross sectional view of a part of the projector screen support in FIG. 5. In a cross section perpendicular to the length axis 22 of the shelf 16, the shelf 16 is bent upwards in the outermost part 19 of the shelf 16 so that the constant force springs 13 are prevented from rolling off the shelf 16. The side 20 of the shelf 16 that is in contact with the constant force spring 13 is provided with contact means 21 which provide low friction between the constant force spring 13 and the contact means 21. The contact means may be some sort of plastic that provides low friction between the constant force spring 13 and the contact means.

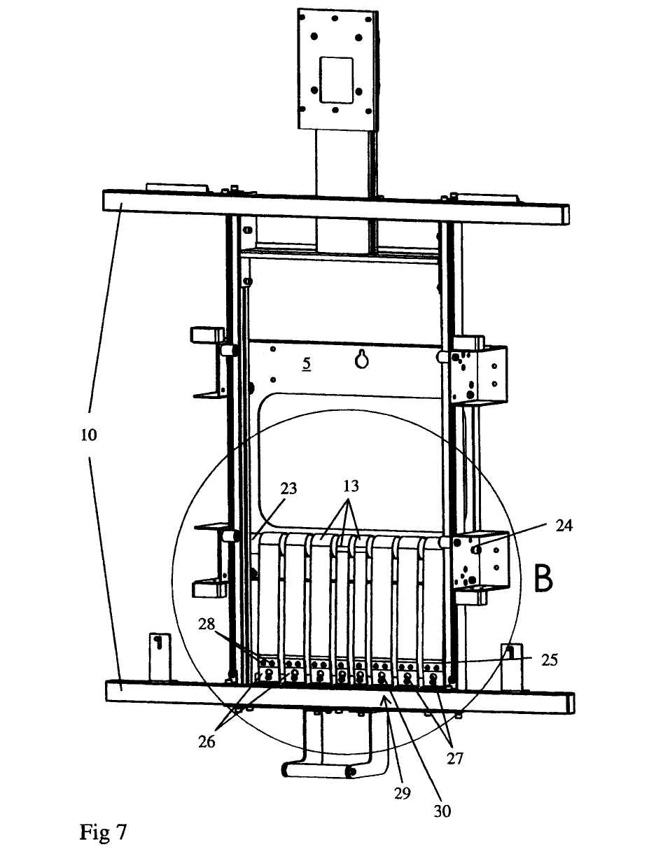

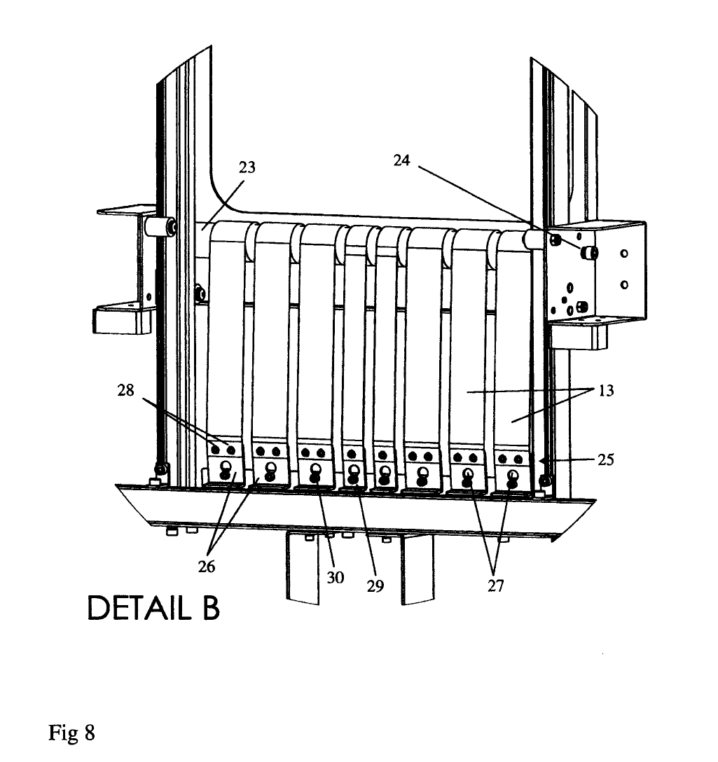

FIG. 7 is a front perspective view of a projector screen support according to an alternative embodiment of the present invention. FIG. 8 shows a part of the projector screen support of FIG. 7 in more detail. Instead of having a shelf for the constant force springs, as described in the embodiments above, the constant force springs 13 are arranged around an axle 23 which is journalled in slide bearings 24 arranged in the support structure 5. In the embodiment in FIG. 7 the constant force springs 13 have two different strengths, i.e., they provide a force of two different magnitudes. The outer ends 25 of the constant force springs 13 are provided with plates 26 each having a key hole formed hole 27. The plates 26 are screwed to the outer ends 25 of the springs 13 by means of attachment screws 28. The outer parts 29 of the plates are bent at an angle in relation to the rest of the plates. Knobs in the form of screws 29 with screw heads 30 are arranged in the screen holding support. When the springs 13 are to be attached to the screws 29 they are pulled down to the screws 29 so that the screw heads 30 may be inserted through the wide parts of the holes 27. When the pulling force is released the springs are drawn upwards by the spring force so that the screws are positioned in the narrow part of the holes 27. The screws may then be tightened to secure the plates 26 to the support structure 5.

The support structure 5 may be arranged to be attached to a wall. Alternatively the support structure may be arranged to be attached to a base to be placed on the floor.

The described embodiments may be modified in many ways without departing from the spirit and scope of the present invention which is limited only by the appended claims.

It is possible to have an arbitrary number of constant force springs. It is not necessary to have a common shelf for all the constant force springs. It is possible to have a shelf for each one of the constant force springs.

In the shown embodiments the axes of the constant force springs are arranged parallel to the projector screen. It is, however, possible to arrange the axes of the constant force springs perpendicular to the projector screen.

The constant force springs may be rotatably attached to the axle.

1. A projector screen support, comprising a support structure with at least one guide means defining a length axis which is to be arranged essentially vertically, a screen holding support for holding a projector screen, which screen holding support is arranged movable along the length axis, defined by said at least one guide means, in relation to said at least one guide means on the support structure, and counterbalancing means arranged to apply a force directed upwards on the screen holding support in relation to the support structure, wherein the counterbalancing means comprises at least two constant force springs in the form of rolled ribbons of spring steel, which each have a roll axis, wherein the roll axes are arranged essentially parallel to each other, wherein each spring produces a pre-determined force, wherein the springs are attachable/detachable in at least one end, so that the total force from the counter-balancing means may be easily varied by attaching or detaching springs.

2. The projector screen support according to claim 1, wherein the springs are attachable/detachable without using any tools.

3. The projector screen support according to claim 1, wherein the outer end of at least one of the constant force springs is provided with a hole having a decreasing width towards the outer end of the constant force spring, which hole is to be in engagement with a knob having a length axis and a form at the outer end of the knob so that when the outer end of the hole is in engagement with the knob the outer end of the spring is prevented from moving along the length axis of the knob out of engagement with the knob.

4. The projector screen support according to claim 3, wherein the knob is a screw with a screw head.

5. The projector screen support according to claim 4, wherein the attached spring may be secured by tightening the screw.

6. The projector screen support according to claim 3, wherein a plate is arranged attached to the outer end of the constant force spring, in which plate the hole is formed.

7. The projector screen support according to claim 1, wherein the constant force springs comprise springs of at least two different strengths, i.e. which produce forces of at least two different magnitudes.

8. The projector screen support according to claim 1, wherein the support structure comprises a shelf on which the constant force springs may be arranged rotatable around their roll axes.

9. The projector screen support according to claim 8, wherein the shelf comprises a length axis which is arranged essentially perpendicular to the length axis defined by said at least one guide means and wherein the constant force springs are arranged to be placed on the shelf with their roll axes essentially parallel to the length axis of the shelf.

10. The projector screen support according to claim 9, wherein the shelf in a cross section perpendicular to the length axis of the shelf is bent upwards in the outermost part of the shelf so that the constant force springs are prevented from rolling off the shelf.

11. The projector screen support according to claim 8, wherein the side of the shelf that is arranged to be in contact with the constant force spring is provided with contact means which provide low friction between the constant force spring and the contact means.

12. The projector screen support according to claim 1, wherein the constant force springs are arranged fixed in relation to the support structure, and are arranged attachable/detachable in relation to the screen holding support without the use of any tools.

13. The projector screen support according to claim 1, wherein the inner end of the constant force spring is arranged around an axle.

14. The projector screen support according to claim 12, wherein the axle is journalled in the support structure.

15. The projector screen support according to claim 11, wherein the axle is journalled in slide bearings.

16. The projector screen support according to claim 1, wherein the support structure is arranged to be attached to a wall.

17. The projector screen support according to claim 1, wherein the screen holding support also comprises an arm extending essentially perpendicularly to said at least one guide means, wherein the arm is arranged for the arrangement of a short throw projector.

18. A projector system, comprising a projector screen support according to claim 1, a projector screen, and a projector.
